(19) United States
(12) Patent Application Publication
(10) Pub. No.: US 2013/0329039 A1
(43) Pub. Date: Dec. 12, 2013

(54) DEFECT INSPECTION METHOD AND DEVICE THEREOF

(71) Applicant: Kaoru Sakai, Yokohama (JP)

(72) Inventor: Kaoru Sakai, Yokohama (JP)

(21) Appl. No.: 13/698,054

(22) PCT Filed: Jul. 6, 2011
(86) PCT No.: PCT/JP2011/065499

§ 371 Date: Mar. 12, 2013

(30) Foreign Application Priority Data
Sep. 15, 2010 (JP) 2010-206810

(51) Int. Cl. G06T 7/00

(52) U.S. Cl. CPC G06T 7/0004
USPC 348/126; 382/144

(57) ABSTRACT

In order to highly sensitively detect fatal defects present in the vicinity of a direct peripheral circuit section in a chip formed on a semiconductor wafer, in the defect inspection device, which is provided with an illumination optical system that illuminates an inspection subject at predetermined optical conditions and a detection optical system that acquires image data by detecting scattered light from the inspection subject at predetermined detection conditions, a plurality of different defect determinations are performed for each region from a plurality of image data that differ in image data acquisition conditions or optical conditions and that are acquired by the detection optical system, and defect candidates are detected by consolidating the results.

### TECHNICAL FIELD

The present invention relates to an inspection which detects a fine pattern defect, a foreign material, etc. from an image (image to be detected) of an inspection subject, which has been obtained using light or laser or an electron beam or the like. More particularly, the invention relates to a defect inspection method suitable for execution of a defect inspection of a semiconductor wafer, a TFT, a photomask or the like, and a device thereof.

### BACKGROUND ART

As a related art which compares a detected image and a reference image to perform defect detection, there has been known a method described in Japanese Patent No. 2976550 (Patent Document 1). This individually performs a cell comparison inspection and a chip comparison inspection. The cell comparison inspection acquires images of a large number of chips formed on a semiconductor wafer on a regular basis, mutually compares adjacent repetitive patterns in the same chip with respect to a memory mat unit formed in cyclic patterns in each chip relative to the acquired chip's images and detects its inconsistent part as a defect. The chip comparison inspection compares corresponding patterns between a plurality of adjacent chips with respect to a peripheral circuit section formed in non-cyclic patterns and detects its inconsistent part as a defect.

Further, there is known a method described in Japanese Patent No. 3808320 (Patent Document 2). This performs both of a cell comparison inspection and a chip comparison inspection on a memory mat section in each chip set in advance and consolidates the results thereof to detect a defect. These related arts aim to define in advance layout information about the memory mat section and the peripheral circuit section or to acquire the same in advance and switch between comparison systems in accordance with the layout information.

When regions having a plurality of different cycles exist in mixed form within a chip herein although the cell comparison inspection in which the distance between patterns to be compared is made short is more highly sensitive than the chip comparison inspection, the definition of the layout information of the memory mat section for performing the cell comparison inspection, and the acquisition thereof in advance become complicated in the related arts. Even in the case of the peripheral circuit section, patterns having periodicity often exist in mixed form therein. In the related art, however, it was difficult to perform the cell comparison inspection on these. Even if the cell comparison inspection was considered possible, the setting thereof was more cumbersome.

### PRIOR ART DOCUMENTS

### Patent Documents

Patent Document 1: Japanese Patent No. 2976550
Patent Document 2: Japanese Patent No. 3808320

### SUMMARY OF THE INVENTION

### Problems to be Solved by the Invention

In a semiconductor wafer that is an inspection subject, a subtle difference in film thickness occurs in each pattern even in the case of adjacent chips due to planarization or the like by CMP (Chemical Mechanical Polishing). A difference in brightness locally occurs in images between chips. There is also a difference in brightness between chips due to variations in the size of each pattern. On the other hand, a cell comparison that performs a comparison with each adjacent pattern in the same chip is adaptable to a memory mat section composed of cyclic patterns within each chip as in the related art system. When, however, a plurality of different memory mat sections exist in each chip, the definition thereof becomes cumbersome. A non-memory mat section has no other choice but to perform a chip comparison. It is thus difficult to perform a highly sensitive inspection thereon.

An object of the present invention is to provide a defect inspection method which makes unnecessary the setting of pattern layout information within a complicated chip and the input of information in advance by a user and is capable of performing a defect detection that is as a highly sensitive as possible, even on a non-memory mat section, and a device thereof.

### Means for Solving the Problems

In order to achieve the above object, the present invention is provided with a unit which inputs layout information of each pattern, and a unit which performs every region, a plurality of different defect determination processes on an image to be inspected from the obtained layout information of pattern and consolidates a plurality of results obtained to detect defect candidates, thereby executing the optimum defect determination process for each region.

In the present invention, as one of a plurality of different defect determination processes, the direction of a pattern cycle and the cycle (pattern pitch) are calculated every smaller region in a region to perform a cyclic pattern comparison.

That is, in order to achieve the above object, the present invention provides a device inspecting each of patterns formed on a sample, which is configured to include table unit which places the sample thereon and is continuously movable in at least one direction, image acquiring unit which images the sample placed on the table unit to acquire an image of each pattern formed on the sample, split condition setting unit which sets conditions for splitting the image of the pattern acquired by the image acquiring unit in a plurality of regions, and region-specific defect determining unit which splits the image of the pattern acquired by the image acquiring means, based on the conditions for the splitting set by the split condition setting unit and performs a defect determination process suitable for the region for each split region to detect a defect of the sample.

Further, in order to achieve the above object, the present invention provides a method of inspecting each of patterns formed on a sample, which comprises imaging the sample while continuously moving the sample to acquire an image of each pattern formed on the sample, splitting the acquired image of the pattern, based on conditions for splitting the image of the pattern in a plurality of regions set in advance, and performing a defect determination process suitable for the region for each split region to detect a defect of the sample.

### Effects of the Invention

According to the present invention, a region in which a defect determination by a chip comparison is performed is minimized, a difference in brightness between chips is suppressed, and high sensitive defect detection is enabled over a wide range.

### BRIEF DESCRIPTION OF THE DRAWINGS

FIG. 1A is one embodiment of a defect detection process conducted in an image processing section;

FIG. 1B is a flow diagram of the defect detection process conducted in the image processing section;

FIG. 2 is a block diagram showing the concept of a configuration of a defect inspection device;

FIG. 3 is a block diagram showing a schematic configuration of the defect inspection device;

FIG. 4A is a diagram for describing a state in which an image of each chip is split in a wafer moving direction and a state in which respective split images are respectively distributed to a plurality of processors;

FIG. 4B is a diagram for describing a state in which an image of each chip is split in a wafer moving direction and a perpendicular direction and a state in which respective split images are respectively distributed to a plurality of processors;

FIG. 4C is a diagram showing a state in which in order to detect defect candidates, split images corresponding to a plurality of chips are input to the same processor;

FIG. 5A is a plan view of a wafer, which shows the relationship between the arrangement of chips on the wafer and partial images at the same positions in the respective chips;

FIG. 5B is a diagram showing a configuration of a defect candidate detection process performed in a defect candidate detection unit 8-2;

FIG. 6A is a diagram in which an inspection image is split and displayed every region, and is a diagram showing an example in which a plurality of different defect determination processes are defined;

FIG. 6B is a layout diagram showing layout information of an inspection image;

FIG. 6C is an inspection image showing respective regions defined by layout information;

FIG. 7 is an example illustrative of a flow diagram showing a flow of a defect determination process;

FIG. 8A is a graph showing images obtained by imaging cyclic patterns and brightness of respective pixels taken along the direction indicated by arrow B in the images;

FIG. 8B is a flow diagram showing a flow of a cyclic pattern comparison process and a flow of a process for comparing a minimum value of a difference and a threshold value to detect a defect candidate;

FIG. 8C is a flow diagram showing a flow of a cyclic pattern comparison process and a flow of a process for generating a histogram of a minimum value indicative of a brightness difference to detect a defect candidate;

FIG. 9A is a graph showing images obtained by imaging cyclic patterns and brightness of respective pixels taken along the direction indicated by arrow B in the images;

FIG. 9B is a flow diagram showing a flow of a process for comparison with characteristics of a plurality of cyclic patterns and a flow of a process for generating a histogram of a minimum value of an average brightness difference between a plurality of patterns to detect each defect candidate;

FIG. 10(a) is a diagram showing the concepts of small regions A and B provided in an image, and FIG. 10(b) is a graph obtained by plotting the total sum of brightness differences of pixels in the small region A and pixels in the small region B while shifting the small region B in a perpendicular direction one pixel by one pixel;

FIG. 11A is two images different in image acquisition conditions; and

FIG. 11B is a flow diagram showing a flow of a process for consolidating the characteristics of the two images different in image acquisition conditions to perform a defect determination.

### MODE FOR CARRYING OUT THE INVENTION

Modes for carrying out a defect inspection device according to the present invention and a method thereof will be described using the accompanying drawings. The mode for carrying out the defect inspection device by dark field illumination targeted for a semiconductor wafer taken as an inspection subject will first be explained.

### Embodiment 1

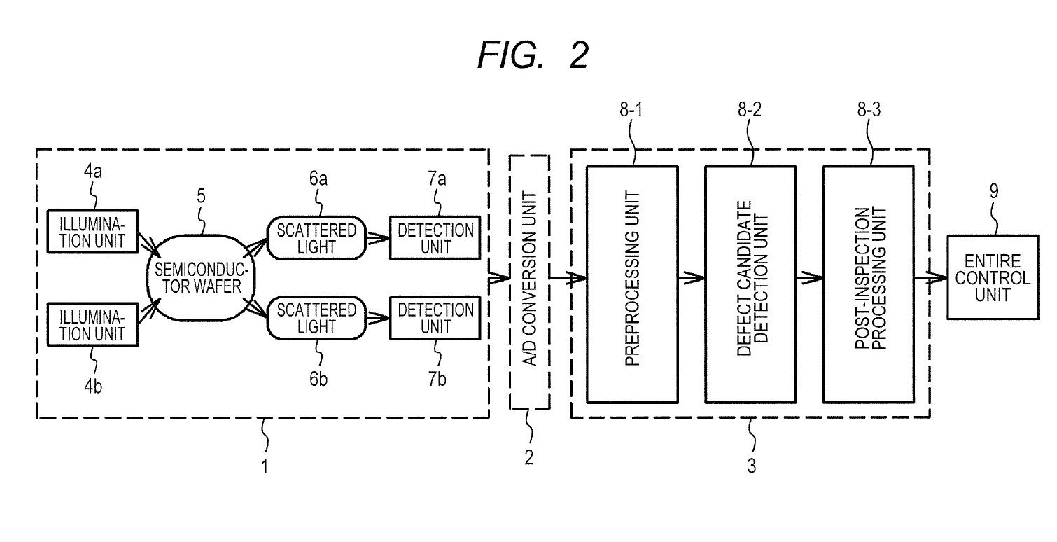

FIG. 2 is a conceptual diagram showing a mode for carrying out the defect inspection device according to the present invention. An optical section 1 is configured to have a plurality of illumination units 4a and 4b and a plurality of detection units 7a and 7b. The illumination units 4a and 4b respectively illuminate an inspection subject 5 (semiconductor wafer) with light having illumination conditions (different in terms of any one of e.g., an illumination angle, an illumination orientation, an illumination wavelength and a polarization state) different from each other. Scattered light 6a and scattered light 6b are generated from the inspection subject 5 by illumination lights outputted from the illumination units 4a and 4b respectively. The detection units 7a and 7b respectively detect the generated scattered lights 6a and 6b as scattered light intensity signals. The detected scattered light intensity signals are respectively amplified by an A/D conversion unit 2 and subjected to A/D conversion thereat, followed by being input to an image processing section 3.

The image processing section 3 is configured to have a preprocessing unit 8-1, a defect candidate detection unit 8-2 and a post-inspection processing unit 8-3 as appropriate. The preprocessing unit 8-1 performs a signal correction, an image split and the like to be described later on the scattered light intensity signals input to the image processing section 3. The defect candidate detection unit 8-2 performs a process to be described later from an image generated at the preprocessing unit 8-1 to thereby detect a defect candidate. The post-inspection processing unit 8-3 excludes noise and Nuisance defects (defect species and non-fatal defects made unnecessary by a user) from the defect candidate detected by the defect candidate detection unit 8-2, performs classification corresponding to the defect species and their size estimation on the remaining defects and outputs the results thereof to an entire control unit 9. Although FIG. 2 shows an embodiment in which the scattered lights 6a and 6b are detected by the discrete detection units 7a and 7b, they may be detected in common by one detection unit. The illumination units and the detection units are respectively not limited to two in number, but may be one or three or more.

The scattered light 6a and the scattered light 6b respectively indicate scattered light distributions generated in association with the illumination units 4a and 4b. If an optical condition for the illumination light by the illumination unit 4a and an optical condition for the illumination light by the illumination unit 4b are different from each other, the scattered light 6a and the scattered light 6b generated by the respective illumination units are different from each other. In the present embodiment, the optical property of scattered light generated by given illumination light and its characteristics are called a scattered light distribution of the scattered light. More specifically, the scattered light distribution indicates a distribution of optical parameters such as the intensity, amplitude, phase, polarization, wavelength, coherency and the like with respect to the output position, output orientation and output angle of the scattered light.

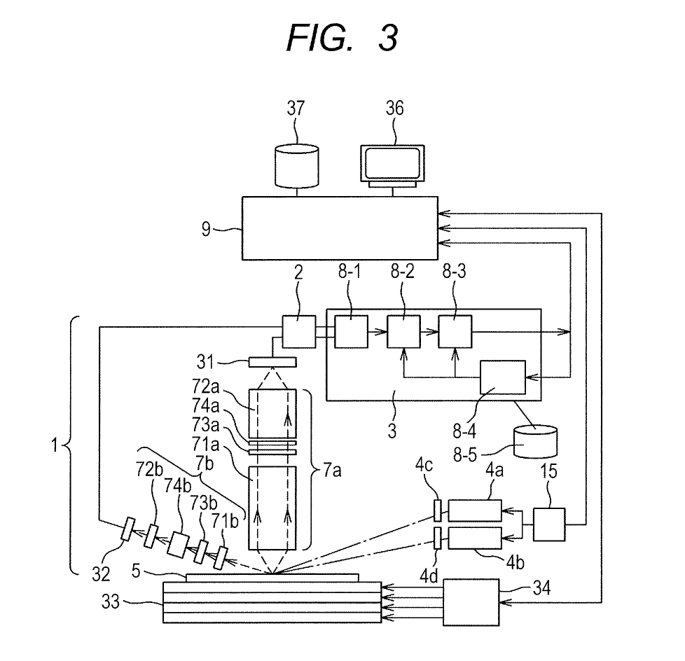

A configuration taken as one embodiment of a concrete defect inspection device for realizing the configuration shown in FIG. 2 is shown in FIG. 3. That is, the defect inspection device according to the present embodiment is configured to include an optical system 1. The optical system 1 has: a plurality of illumination units 4a and 4b which illuminate an inspection subject (semiconductor wafer 5) with illumination light from an oblique direction; a detection optical system (upper detection system) 7a for focusing the scattered lights in the direction perpendicular as viewed from the semiconductor wafer 5 for image formation; a detection optical system (oblique detection system) 7b for focusing scattered lights in an oblique direction for image formation; and sensor units 31 and 32 which receive optical images focused by the detection optical systems and convert the same into image signals. The defect inspection device further include: an A/D conversion unit 2 which amplifies the so-obtained image signals and performs A/D conversion thereon; an image processing section 3; and an entire control unit 9.

The semiconductor wafer 5 is mounted on a stage (X-Y-Z-θ stage) 33 capable of moving and rotating within an XY plane and movable in a Z direction perpendicular to the XY plane. The X-Y-Z-θ stage 33 is driven by a mechanical controller 34. At this time, the semiconductor wafer 5 is placed on the X-Y-Z-θ stage 33, and scattered light from each foreign material on the semiconductor wafer 5 being an inspective subject is detected while the X-Y-Z-θ stage 33 is being moved in the horizontal direction, thereby obtaining the result of detection as a two-dimensional image.

As illumination light sources for the illumination units 4a and 4b, laser may be used or lamps may be used. The wavelength of light of each illumination light source may be a short wavelength, or the light may be light (white light) having a wavelength in a broad band. When the light of the short wavelength is used, light (Ultra Violet Light: UV light) having a wavelength (ranging from 160 nm to 400 nm) in an ultraviolet region can also be used to increase a resolution of an image to be detected (detect fine defects). When the laser is of a short-wavelength laser where it is used as the light source, the illumination units 4a and 4b can also be provided with means 4c and 4d for reducing possible coherence. The means 4c and 4d may be configured by rotational diffusion plates or may be such a configuration that a plurality of light fluxes respectively having different optical lengths are generated using a plurality of optical fibers different in optical length from one another, or quartz plates or glass plates or the like and are superimposed on one another. Illumination conditions (such as an illumination angle, an illumination orientation, an illumination wavelength, a polarization state, etc.) are selected by a user or automatically selected. An illumination driver 15 performs settings and control corresponding to the selected conditions.

Of the scattered lights emitted from the semiconductor wafer 5 illuminated with the illumination light by the illumination unit 4a or 4b, light scattered in the direction orthogonal to the semiconductor wafer 5 is converted to an image signal by the sensor unit 31 through the detection optical system 7a. Light scattered in the direction diagonal to the semiconductor wafer 5 is converted to an image signal by the sensor unit 32 through the detection optical system 7b. The detection optical systems 7a and 7b are respectively composed of objective lenses 71a and 71b and imaging lenses 72a and 72b. The lights are respectively gathered and focused on the sensor units 31 and 32 for image formation. The detection systems 7a and 7b configure a Fourier transformation optical system and perform an optical process on the scattered light from the semiconductor wafer 5, e.g., changes, adjustments of optical characteristics by spatial filtering. When the spatial filtering is performed as the optical process here, the illumination lights emitted from the illumination units 4a and 4b and applied to the semiconductor wafer 5 are assumed to be slit-like beams composed of lights substantially parallel to the longitudinal direction because the use of the parallel lights as the illumination lights improves the performance of detection of foreign materials (although means for forming the slit-shaped beams are included in the illumination units 4a and 4b, the description of their detailed configurations is omitted herein).

Each of the sensor units 31 and 32 adopts an image sensor of a time delay integration type (Time Delay Integration Image Sensor: TDI image sensor) configured by two-dimensionally arranging a plurality of one-dimensional image sensors in the image sensor. Signals detected by the individual one-dimensional image sensors in synchronization with the movement of the X-Y-Z-θ stage 33 are transferred to the one-dimensional image sensor of the following stage where their addition is performed, thereby making it possible to obtain a two-dimensional image highly sensitively at a relatively high speed. Using as the TDI image sensor, a parallel output type sensor equipped with a plurality of output taps makes it possible to parallel-process a plurality of outputs from the sensor units 31 and 32 and enables higher-speed detection.

The spatial filters 73a and 73b are placed in Fourier transform surfaces of the objective lenses 71a and 71b and shield specific Fourier components based on scattered light from patterns repeatedly formed on a regular basis to control diffraction scattered light from the patterns. 74a and 74b indicate optical filter means respectively, which are composed of optical elements capable of adjusting light intensities, such as an ND (Neutral Density) filter, an attenuator, etc., or polarization optical elements such as a polarizing plate, a polarization beam splitter, a wave plate, etc., or any of wavelength filters such as a bandpass filter, a dichroic mirror, etc. or a combination of these. Any of the light intensity of detected light, the polarization properties thereof, and wavelength characteristics thereof is controlled or they are controlled in combination.

The image processing section 3 extracts defects on the semiconductor wafer 5 being of the inspection subject and is configured to include a preprocessing unit 8-1 which performs image corrections such as a shading correction, a dark-level correction, etc. on the image signals input via the A/D conversion unit 2 from the sensor units 31 and 32 and splits the same into images of sizes in constant units, a defect candidate detection unit 8-2 which detects defect candidates from the corrected and split images, a post-inspection processing unit 8-3 which eliminates a Nuisance defect and noise from the detected defect candidates and performs sorting and size estimation corresponding to defect species on the remaining defects, a parameter setting unit 8-4 which receives parameters input from outside and sets them to the defect candidate detection unit 8-2 and the post-inspection processing unit 8-3, and a storage unit 8-5 which stores data being respectively processed at the preprocessing unit 8-1, the defect candidate detection unit 8-2 and the post-inspection processing unit 8-3 and the processed data therein. In the image processing section 3, for example, the parameter setting unit 8-4 is configured to be connected to the storage unit 8-5.

The entire control unit 9 is equipped with a CPU (built in the entire control unit 9) which performs various controls. The entire control unit 9 is connected to a user interface unit (GUI unit) 36 having a display means and an input means which receive parameters from a user and display the images of each detected defect candidate, the image of the finally-extracted defect, etc., respectively, and a storage device 37 which stores the feature value of each defect candidate detected by the image processing section 3, its image and the like therein. The mechanical controller 34 drives the X-Y-Z-θ stage 33 based on a control command issued from the entire control unit 9. Incidentally, each of the image processing section 3, the detection optical systems 7a and 7b and the like is also driven by a command issued from the entire control unit 9.

The semiconductor wafer 5 being the inspection subject have e.g., chips of the same patterns each having a memory mat section and a peripheral circuit section, which are arranged in large numbers and on a regular basis. The entire control unit 9 continuously moves the semiconductor wafer 5 by the X-Y-z-θ stage 33, sequentially captures images of the chips from the sensor units 31 and 32 in synchronization with its movement. The entire control unit 9 automatically generates a reference image not including defects with respect to each of the images of the two types of scattered lights (6a and 6b) obtained, and compares the generated reference image and the sequentially-captured images of chips to extract defects.

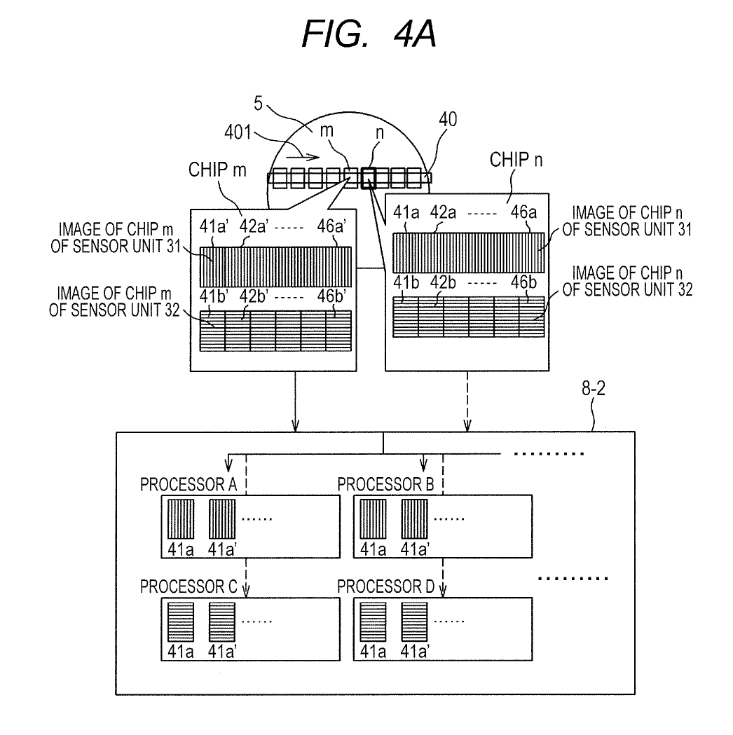

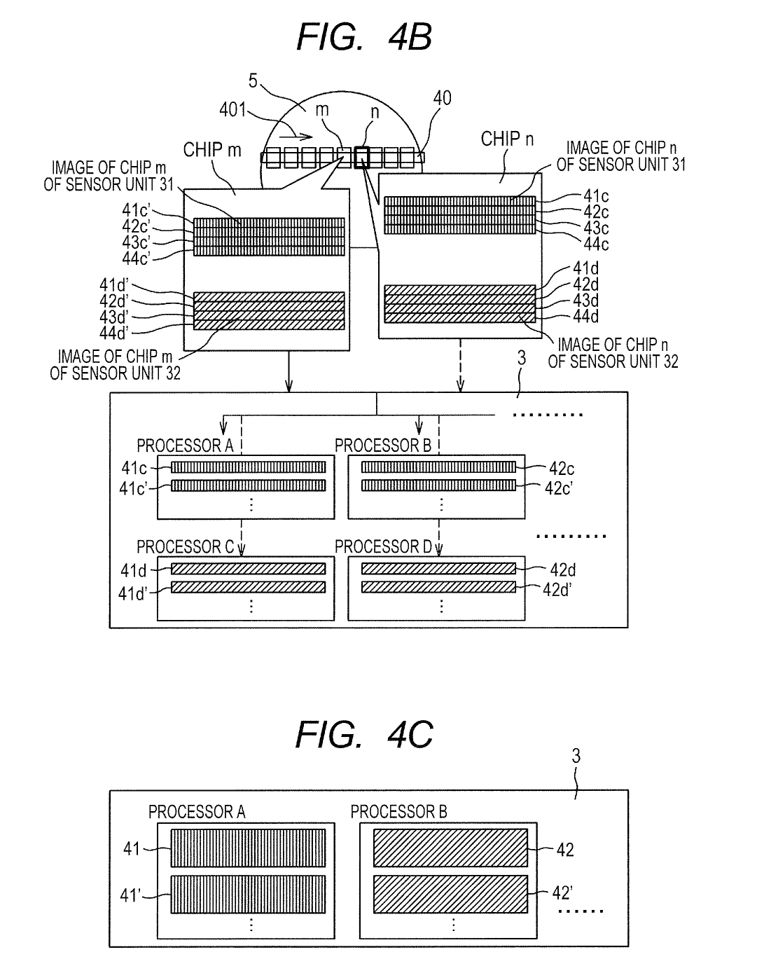

A flow of their data is shown in FIG. 4A. Assumes that at the semiconductor wafer 5 illuminated with a slit-shaped beam from the illumination unit 4a or 4b, e.g., the X-Y-z-θ stage 33 is scanned to thereby obtain images of a band-like region 40 placed on the semiconductor wafer 5 in a direction (direction perpendicular to the longitudinal direction of the slit-shaped beam applied onto the semiconductor wafer 5) indicated by arrow 401. When a chip n is assumed to be an inspection chip, 41a, 42a, . . . , 46a are respectively split images (i.e., images each obtained for each time obtained by splitting the time taken to image the chip n in six) obtained by splitting an image of the chip n obtained from the sensor unit 31 in six in the traveling direction of the X-Y-Z-θ stage 33. 41a′, 42a′, . . . , 46a′ are respectively split images obtained by splitting a chip m adjacent to the chip n in six as with the chip n. These split images obtained from the same sensor unit 31 are shown in vertical stripes. On the other hand, 41b, 42b, 46b are respectively split images obtained by splitting an image of a chip n obtained from the sensor unit 32 in six in the traveling direction of the X-Y-Z-θ stage 33 in like manner. 41b′, 42b′, 46b′ are respectively split images obtained by splitting an image of a chip m in six in the direction (direction indicated by arrow 401) to acquire images in like manner. These split images obtained from the same sensor unit 32 are shown in horizontal stripes.

In the present embodiment, the preprocessing unit 8-1 splits each of the images of the two different detection systems (7a and 7b of FIG. 3) input to the image processing section 3 in such a manner that each split position corresponds between the chip n and the chip m, and inputs each split image to the defect candidate detection unit 8-2. The defect candidate detection unit 8-2 is composed of a plurality of processors A, B, C, D . . . operated in parallel as shown in FIG. 4A. The respective corresponding images (e.g., the split images 41a and 41a′ at their corresponding positions of the chips n and m, which have been obtained by the sensor unit 31, the split images 41b and 41b′ at their corresponding positions of the chip n and the chip m, which have been obtained by the sensor unit 32, and the like) are input to the same processor. The respective processors A, B, C, D . . . respectively perform in parallel, detection of defect candidates from the split images at their corresponding spots of the chips, which have been input from the same sensor unit. Incidentally, the preprocessing unit 8-1 and the post-inspection processing unit 8-3 are also composed of a plurality of processing circuits or a plurality of processors and are capable of parallel processing, respectively.

Thus, when images of the same region that differ in the combination of optical and detection conditions are simultaneously input from the two sensor units, the detection of defect candidates is performed in parallel (e.g., the parallel form of the processor A and the processor C, the parallel form of the processor B and the processor D, and the like in FIG. 4A) by the plural processors. On the other hand, the detection of the defect candidates can also be performed in time series from the images different in the combination of the optical and detection conditions. For example, how to allocate the split images to the respective processors and which image should be used for defect detection can freely be set as in the cases of where after the detection of defect candidates has been performed from the split images 41a and 41a′ by the processor A, the detection of defect candidates is performed from the split images 41b and 41b′ by the same processor A, or the split images 41a, 41a′, 41b and 41b′ different in the combination of the optical and detection conditions are integrated by the same processor A to detect defect candidates, and the like.

Defect determinations can also be performed by changing the direction of splitting of the so-obtained images of each chip. A flow of their data is shown in FIG. 4B. Concerning a chip n to be inspected with respect to the above images of band-like region 40, 41c, 42c, 43c and 44c are respectively split images obtained by splitting the image obtained from the sensor unit 31 in four in a direction (width direction of the sensor unit 31) perpendicular to the direction of traveling of the sensor's stage. 41c′, 42c′, 43c′ and 44c′ are respectively split images obtained by splitting an adjacent chip m in four in like manner. These images are shown in vertical stripes. Likewise, images (41d through 44d and 41d′ through 44d′) obtained from the sensor unit 32 and split in like manner are illustrated in oblique lines. The split images at the respective corresponding positions are input to the same processor to perform the detection of defect candidates in parallel. Of course, the so-obtained images of respective chips may also be processed by being input to the image processing section 3 without splitting.

41c through 44c of FIG. 4B are respectively the images of the chip n in the band-like region 40, which have been obtained from the sensor unit 31, and 41c′ through 44c′ are respectively the images of the adjacent chip m therein, which have been obtained from the sensor unit 31. Likewise, 41d through 44d are respectively the images of the chip n, which have been obtained from the sensor unit 32, and 41d′ through 44d′ are respectively the images of the chip m, which have been obtained from the sensor unit 32. Thus, the images at their corresponding positions in the chips, which have been obtained from the same sensors, are input to the same processors without splitting every detection time as described in FIG. 4A, where the detection of each defect candidate can also be performed.

Incidentally, although each of FIGS. 4A and 4B has shown the example in which the corresponding split images of the two chips n and m adjacent to each other are input to the same processor to perform defect detection, corresponding split images of one or plural chips (number of chips formed in the semiconductor wafer 5 at the maximum) are input to the processor A, and the detection of defect candidates can also be performed using all of these, as shown in FIG. 4C. In either case, with respect to the respective images under the plural optical conditions, the images (may or may not be split) at their corresponding positions of the chips are input to the same processor, and the defect candidate is detected for each image under the optical conditions or by integrating the images under the optical conditions.

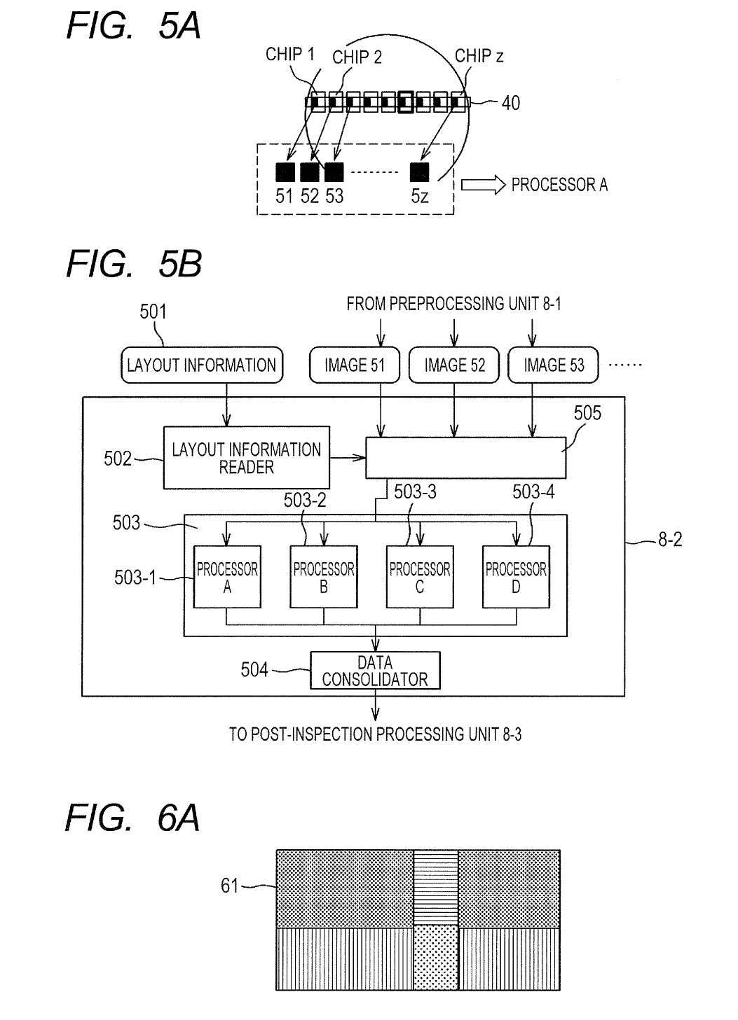

A flow of a process of the defect candidate detection unit 8-2 of the image processing section 3, which is performed at each processor, will next be explained. The relationship between the chips 1, 2, . . . , chip z of the band-like region 40 obtained from the sensor unit 31 by scanning of the stage 33 at the semiconductor wafer 5, which has been shown in FIGS. 4A and 4B, and split images 51, 52, . . . , 5z of their corresponding regions is shown in FIG. 5A. An outline of the constitution of the process of the defect candidate detection unit 8-2 that inputs the split images 51, 52, . . . , 5z to the processor A and detects defect candidates present in the split images 51, 52, . . . , 5z is shown in FIG. 5B.

The defect candidate detection unit 8-2 is equipped with a layout information reader 502, a multi defect determination unit 503 which performs a plurality of processes different for each region in accordance with layout information and detects each defect candidate, a data consolidator 504 which consolidates information detected by the different processes from the respective regions, and an image memory 505 which temporarily stores the images 51, 52, 53 . . . input from the preprocessing unit 8-1. The multi defect determination unit 503 is equipped with a processor A 503-1, a processor B 503-2, a processor C 503-3 and a processor D 503-4 that execute a plurality of different defect determination processes. First, the image 51 of the first chip, the image 52 of the second chip, the image 53 of the third chip, . . . are sequentially input to the defect candidate detection unit 8-2 via the preprocessing unit 8-1. The layout information 501 is also input to the defect candidate detection unit 8-2. The defect candidate detection unit 8-2 temporarily stores the input images in the image memory 505.

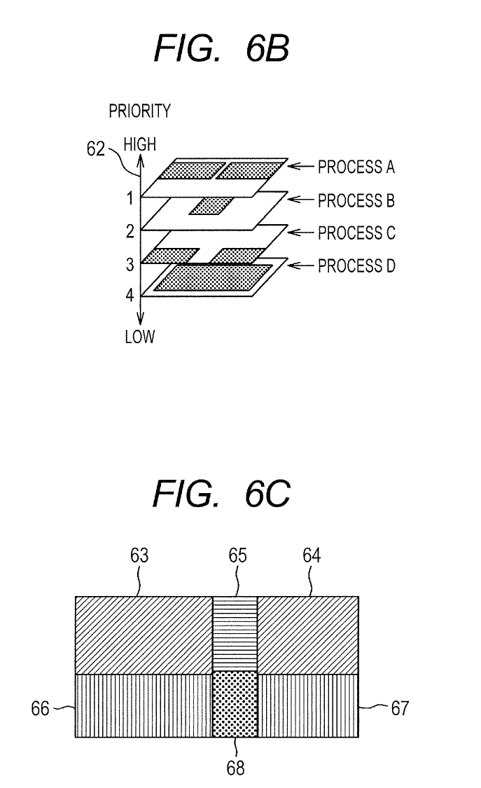

An example of the input layout information 501 will next be explained using each of FIGS. 6A, 6B and 6C. There is shown an example in which 61 in FIG. 6A is one of the split images equivalent to 51, 52, . . . , 5z in FIG. 5A, which becomes a target for processing, 62 in FIG. 6B is an index value of priority of layout information set and input to the target image 61, and 63 through 68 in FIG. 6C are split images defined by the index value 62 of the priority of the layout information with respect to the target image 61. The index value 62 of the priority of the layout information designates which process of multi defect determination processes should be allocated to each region of the target image 61 together with its range. There is shown here, an example in which the two upper spots of the target image 61, i.e., diagonally-shaded regions 63 and 64 shown in FIG. 6C in the target image 61, the upper band-like spot (region 65 shown in horizontal lines), the two lower spots (regions 66 and 67 shown in vertical lines) of the target image 61, and the entire region of the target image 61 are respectively designated by their corresponding layout information so as to be subjected to a defect determination process A, a defect determination process B, a defect determination process C and a defect determination process D. In the present example, the regions corresponding to the regions 63 through 67 are to carry out two different defect determination processes.

Thus, a plurality of processes can also be set to the same region. When different defect candidates are detected in a region in which a plurality of different defect determination processes are carried out, whether any detected result should be given priority is defined in layout information. The index value 62 of the priority of the layout information in FIG. 6B explicitly shows priorities for the respective defect determination processes. As the index value exists above, the priority is high. For example, the regions 63 and 64 are respectively set so as to perform the process A at the highest stage of the index value 62 of the priority of the layout information and the process D at the lowest stage of the index value 62 of the priority of the layout information.

Here, the process A and the process D are performed in the regions 63 and 64 and the logical product (AND) of results detected at the processes A and D is basically taken, that is, one detected in common between the process A and the process D is taken as a defect. When the result of detection is an inconsistent one, the result of the process A high in priority can also be output by priority. Further, the logical sum (OR) of results detected at the process A and the process D, i.e., one detected at either of the processes A and D can also be assumed to be a defect. These processes are performed by the data consolidator 504 of FIG. 5B. A region 68 (region of lattice pattern) in FIG. 6C is to perform only the defect determination process D.

Incidentally, such layout information 501 is set in advance by a user through the user interface unit 36. If, however, design data (CAD data) indicative of a pattern layout, a line width, a cycle (pitch) of each repetitive pattern, etc. to be targeted are available, the regions to which the respective processes are allocated, and the processes can also be automatically set from the design data.

In the present embodiment as described above, one or more different defect determination processes are executed at the multi defect determination unit 503 for each region, based on the layout information 501 with respect to the split images (51, 52, . . . , 5z in FIG. 5A) targeted for inspection to thereby detect each defect candidate. There is shown as an example of a defect determination process, a chip comparison in which the characteristics of each pixel in an inspection image are compared with the characteristics of each pixel in an image at a corresponding position, of an adjacent chip, and a pixel large in characteristic difference is detected as a defect candidate.

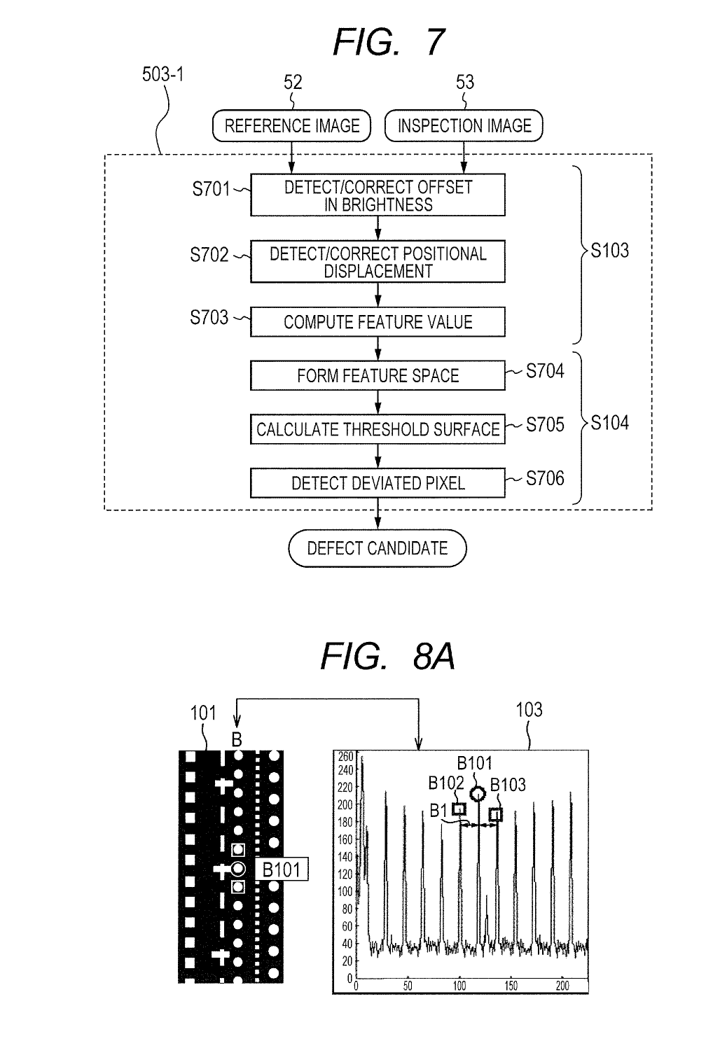

An example of a defect determination process by chip comparison, which is executed by the processor A 503-1, is shown in FIG. 7. Assume that an inspection image is the image 53 at the third chip as viewed from the left of FIG. 5A, the image 52 at the corresponding position, of its adjacent chip is taken as a reference image, and a comparison between them is preformed. In the semiconductor wafer 5, the same patterns are formed on a regular basis as described above, and the reference image 52 and the inspection image 53 should be assumed to be originally identical. However, in a semiconductor wafer 5 formed with a multilayer film, a large difference in brightness between images occurs due to the difference in thickness between chips. There is therefore a high possibility that the difference in brightness between the reference image 52 and the inspection image 53 will be large. There is also a possibility that a positional displacement of a pattern will also occur due to a slight difference (sampling error) in the position of acquisition of an image at the scanning of the X-Y-Z-θ stage 33.

Therefore, their correction is first conducted in the chip comparison process. First, an offset in brightness between the reference image 52 and the inspection image 53 is detected and its correction is performed (S701). The correction of the offset in brightness may be performed on the entire image inputted or may be conducted only in a region targeted for the chip comparison process. As the process for detection and correction of an offset in brightness, there is shown below an example based on the least squares approximation.

Assuming that the brightness of corresponding pixels of the inspection image 53 and the reference image 52 are f(x, y) and g(x, y) respectively, a linear relationship expressed in (equation 1) is assumed to exist, and “a” and “b” are calculated in such a manner that (equation 2) becomes minimum, and are assumed to be correction coefficients as gain and offset. A brightness correction is performed on all pixel values f(x, y) targeted for brightness correction in the inspection image 53.

g(x,y)=a+b·f(x,y) [Equation 1]

Σ{g(x,y)−(a+b·f(x,y)}² [Equation 2]

L(f(x,y))=gain·f(x,y)+offset [Equation 3]

Next, a positional displacement between images is detected and its correction is performed (S702). This may also be performed on the entire image inputted in like manner or may be performed only in a region targeted for the chip comparison process. As the process for the detection and correction of the amount of positional displacement, a method for determining an offset amount at which the sum of squares of a difference in brightness between one image and the other image becomes minimum while shifting one image, or a method for determining an offset amount at which a normalization correlation coefficient becomes maximum, or the like is adopted in general.

A feature value is computed between each pixel of the inspection image 53 subjected to the brightness correction and the position correction and its corresponding pixel of the reference image 52 with respect to a region targeted for the inspection image 53 (S703). All feature values of the target pixels or some thereof are selected to form feature space (S704). The feature value may be one which represents the characteristics of each pixel. As some examples thereof, there are shown (a) contrast (equation 4), (b) a density difference (equation 5), (c) a brightness variance value of an adjacent pixel (equation 6), (d) a correlation coefficient, (e) an increase or decrease in brightness with respect to the adjacent pixel, (f) secondary differential value, or the like.

Those examples illustrative of these feature values are calculated by the following equations assuming that the brightness of each point of the inspection image 53 is f(x, y), and the brightness of its corresponding reference image 52 is g(x, y).

Contrast; max{f(x,y),f(x+1,y),f(x,y+1),f(x+1,y+1)}−min{f(x,y),f(x+1,y),f(x,y+1),f(x+1,y+1)} [Equation 4]

Density difference; f(x,y)−g(x,y) [Equation 5]

Variance; [Σ{f(x+I,y+j)2}−{Σf(x+i,y+j)}2/M]/(M−1) [Equation 6]
i, j=−1, 0, 1 M=9

In addition, the brightness of the individual images itself is also assumed to be a feature value. One or plural feature values are selected from these feature values. The respective pixels in each image are plotted in feature space with the selected feature values taken as axes according to the values of the feature values to thereby set a threshold surface so as to surround a distribution estimated to be normal (S705). A pixel which is plotted outside the set threshold surface, i.e., a pixel that becomes an outlying or deviation value on the characteristic basis is detected (S706) and outputted as a defect candidate. The data consolidator 504 performs a consolidation determination in accordance with the priority of the layout information. Upon estimation of a normal range, the threshold values may individually be set to the feature values selected by the user, or there may be adopted a method for determining and identifying a probability of a target pixel being a non-defect pixel assuming that a distribution of the characteristics of each normal pixel follows a normal distribution.

In the latter, assuming that d feature values of n normal pixels are x1, x2, . . . , xn, an identification function φ for detecting a pixel whose feature value becomes x, as a defect candidate, is given by (equation 7 and equation 8).

$$P robability density function of x \text{:} \\ p ( x ) = \frac{1}{{( 2 π )}^{\frac{d}{2}} \sqrt{\vert Σ \vert}} exp \{ - \frac{1}{2} {( x - μ )}^{t} ) {Σ}^{- 1} ( x - μ ) \\ μ = \frac{1}{n} {\sum }_{i = 1}^{n} {x}_{i} \qquad [ Equation 7 ]$$

where, μ: average of all pixels

Σ=Σ_{I=}1ⁿ(x−μ)(xᵢ−μ)^{t}

where, Σ: covariance

Identification function φ(x)=1 (if p(x)≧th then non-defect)

0 (if p(x)<th then defect) [Equation 8]

The feature space is formed by pixels in a region targeted for chip inspection. Incidentally, although there has been described the example in which the characteristic comparison is performed on the inspection image 53 with the image at the corresponding position, of the adjacent chip being taken as the reference image 52, a comparison can also be performed with one generated on a statistic basis from images (51, 52, . . . 5z in FIG. 5A) at their corresponding positions, of a plurality of chips being taken as the reference image 52. As a statistic process, the average value of corresponding pixel values of respective pixels may be taken as a brightness value (Equation 9) of the reference image 52. As images used in the generation of the reference image 52, split images (corresponding to the number of all chips formed on the semiconductor wafer 5 at the maximum) at their corresponding positions, of chips arranged in another row can also be added.

S(x,y)=Σ{fn(x,y)}/N [Equation 9]

where N: number of split images used in statistical process

The above is an example illustrative of the chip comparison process being one of the defect determination processes executed in the multi defect determinator 503.

As another example of the defect determination process, may be mentioned, instead of the chip comparison process which makes the comparison with each adjacent chip, a cell comparison process which makes a comparison between adjacent patterns in a cyclic pattern region in a chip (i.e., in the same image area). As a further example of the defect determination process, may be mentioned, a threshold comparison process which carries out a comparison with a threshold value, i.e., detects as a defect, a pixel at which the brightness in a region is greater than or equal to the threshold value thereof. Further, as a still further example of the defect determination process, may be mentioned, a cyclic pattern comparison which splits a target region in an inspection image in small regions of finer units, compares characteristics of cycle patterns with each other for each small region and detects each pixel large in characteristic's difference as a defect candidate.

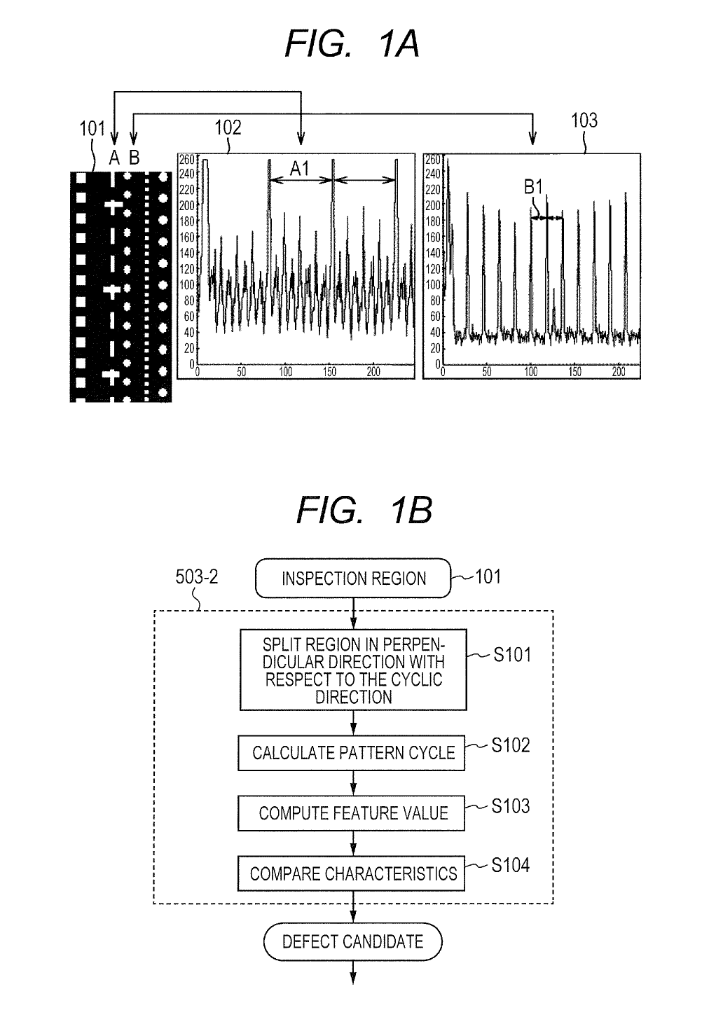

An example of a defect determination process by a cyclic pattern comparison is shown in FIG. 1A as an example of the process executed by the processor B 503-2. 101 is one example of a target region. The region 101 is a region having periodicity in a perpendicular direction of the image. 102 is a signal waveform in the perpendicular direction at a position indicated by arrow A within the region 101, and 103 is a signal waveform in the perpendicular direction at a position indicated by arrow B within the region 101. The cycle of patterns in the perpendicular direction at the position indicated by arrow A is A1, and the cycle of patterns in the perpendicular direction at the position indicated by arrow B is B1. They are different in cycle. Thus, in the present embodiment, a cyclic pattern comparison is performed on such a region that in a region for each pattern having periodicity, patterns having a plurality of cycles exist in mixed form. 100 in FIG. 1B is a flow for its process. First, a region is split in finer small regions in a perpendicular direction with respect to the cyclic direction (horizontal direction of the image in the region 101) with respect to an image 101 of a target region, which is imaged by the optical system 1, preprocessed by the preprocessing unit 8-1 and inputted to the processor B 503-2 of the defect candidate detection unit 8-2 (S101). The cycle of each pattern is calculated for each small region (S102). Next, the feature value is computed with respect to each pixel in the small region (S103). As an example of the process of S103, may be mentioned, the process for S701 through S703 of FIG. 7 previously described as the example of the defect determination process by the chip comparison, or a process similar to S703. All feature values of target pixels or some thereof are selected and compared with the feature value of each pixel spaced by the calculated cycle (S104). Each pixel large in characteristic's difference is detected as a defect candidate. As an example of a process at S104, may be mentioned, one similar to the process for S704 through S706 of FIG. 7. The feature value may be one indicative of the characteristics of each pixel. One embodiment thereof is as shown by the example of the chip comparison.

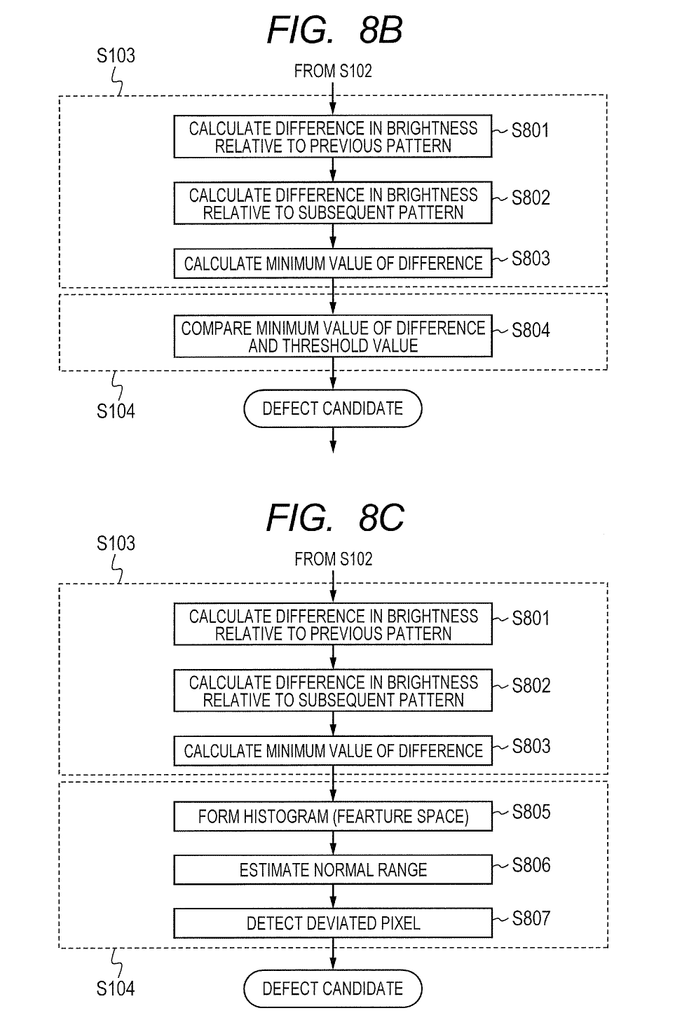

FIG. 8A shows another example illustrative of a feature value computing process (S103) and a characteristic comparison process (S104) in each small region including the position of arrow B of FIG. 1A. Assuming that B101 (a pixel surrounded with o) is a pixel of interest, pixels spaced one cycle (B1) back and forth are B102 and B103 (pixels surrounded with □). Assuming that the characteristic to be compared is a difference in brightness relative to each pixel spaced one cycle back and forth, a difference in brightness relative to the one-cycle preceding pixel B102 is first calculated as shown in FIG. 8B as a process corresponding to the feature value computing process S103 (S801). Subsequently, a difference in brightness relative to the one-cycle after pixel B103 is calculated (S802). Then, the minimum value between the two is calculated (S803). The so-calculated minimum value of difference in brightness becomes a feature value of the pixel B101 to be noted. As a process corresponding to the characteristic comparison process (S104), the minimum value of the brightness difference and the threshold value set in advance are compared (S804), and each pixel at which the minimum value thereof is greater than or equal to the threshold value is detected as a defect candidate. Instead of the comparison between the feature value (minimum value of brightness difference) and the threshold value at S804, a histogram of the minimum value thereof is generated (S805) and a normal distribution is applied thereto to thereby estimate a normal range (S806) as shown in FIG. 8C. Each pixel that deviates from the estimated normal range can also be detected as a defect candidate (S807).

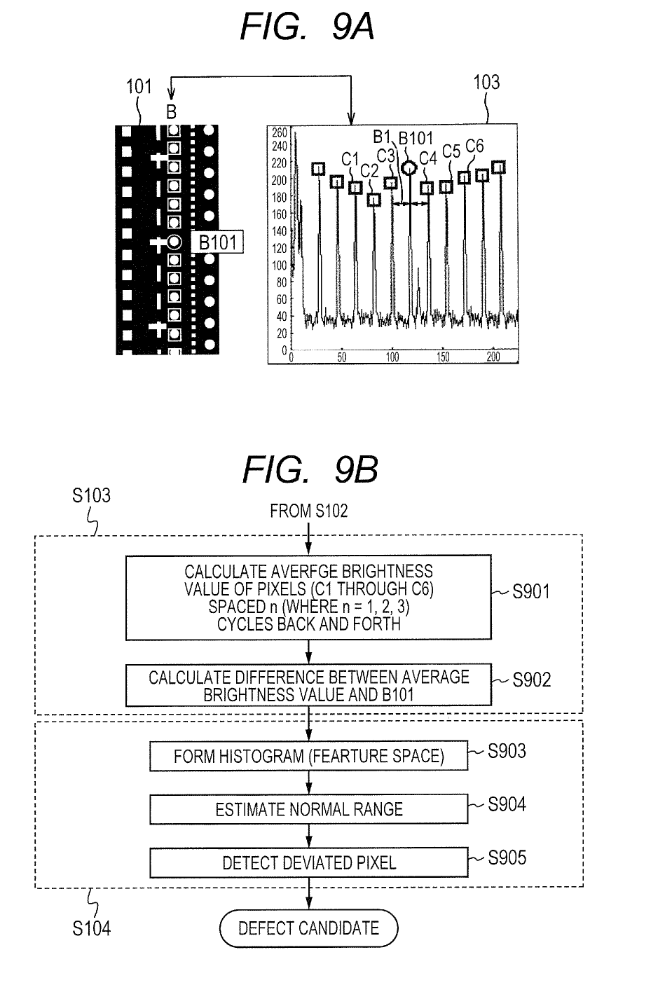

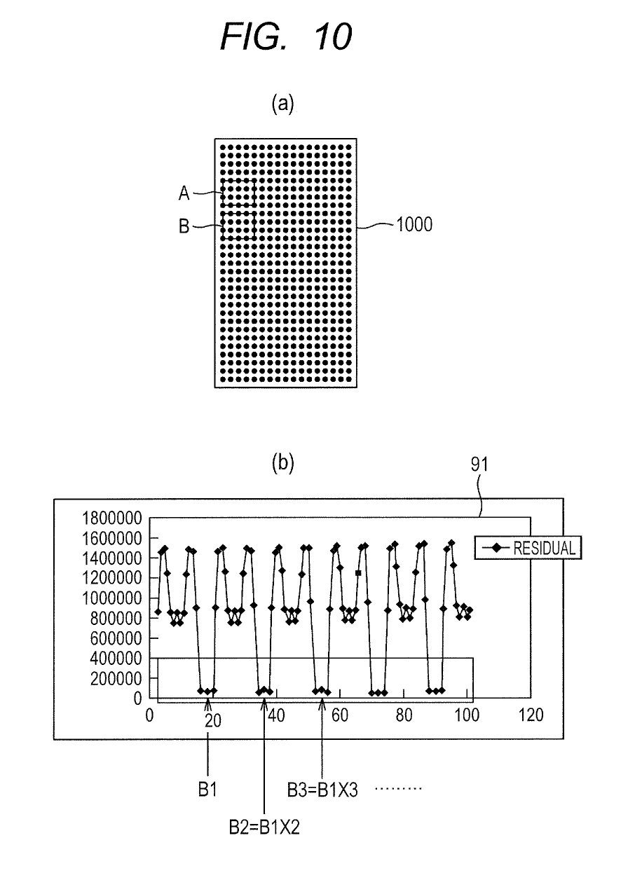

Although the example described above is the example in which the comparison is carried out with the characteristics of each pixel spaced one cycle back and forth, a comparison can also be made with the characteristics of a plurality of patterns including patterns spaced further by plural times the one cycle. FIG. 9A shows one example of its process. Concerting a pixel B101 (a pixel surrounded with o) which is a pixel of interest, pixels spaced n cycles (B1×n, n=1, 2, 3, . . . ) back and forth are respectively C1, C2, . . . , C6, etc. (pixels surrounded with □). Here, when the pixels C1 through C6 six in total spaced three cycles at maximum back and forth are used for feature values, the average value of brightness of C1, C2, . . . , C6 is first calculated as shown in FIG. 9B as a process corresponding to the feature value computing process (S103) of FIG. 1B (S901). Here, a median value may be used instead of the average value of brightness of the six pixels C1, C2, . . . , C6. Next, a difference between the average brightness value of the six pixels or a central brightness value and the pixel B101 to be noted is calculated (S902). This results in the feature value of the pixel (B101) of interest.

As a process corresponding to the characteristic comparison process (S104) of FIG. 1B, as with the process described in FIG. 8C, a histogram of a difference is formed (S903), and a normal distribution is applied thereto to thereby estimate a normal range (S904). Each pixel that deviates from the estimated normal range can also be detected as a defect candidate (S905).

There has been shown as described above, the example in which when the periodicity of patterns exists in the perpendicular direction (Y direction) of the image, the feature value has been determined referring to each pixel spaced by the cycle of patterns in the perpendicular direction. The coordinates of a reference pixel relative to a coordinate (x, y) of a pixel of interest are (x, y−B1) and (x, y+B1). On the other hand, when the periodicity exists in a horizontal direction (X direction) of the image, a feature value can also be determined referring to each pixel spaced by a cycle of patterns in the horizontal direction. The coordinates of the reference pixel in this case are (x−B1, y) and (x+B1, y).

Here, the cycle of each pattern and the direction of the cycle (horizontal or vertical direction or the like) may be set from the layout information, but may automatically be calculated. An example thereof is shown in FIG. 10. 91 of FIG. 10(b) is one plotted by providing a small region A in an image 1000 of FIG. 10(a) and calculating the sum of brightness differences between each pixel (x, v) in the small region A and each pixel (x, y) in a region B of the same size of the small region A while shitting the region B one pixel by one pixel in the perpendicular direction. Spots at which the brightness difference becomes small periodically become pattern cycles. Fluctuation waveforms of such brightness differences are calculated in the horizontal and vertical directions. It is checked whether the periodicity exists in the waveforms. The cyclic direction and the cycle (pattern pitch) are automatically calculated.

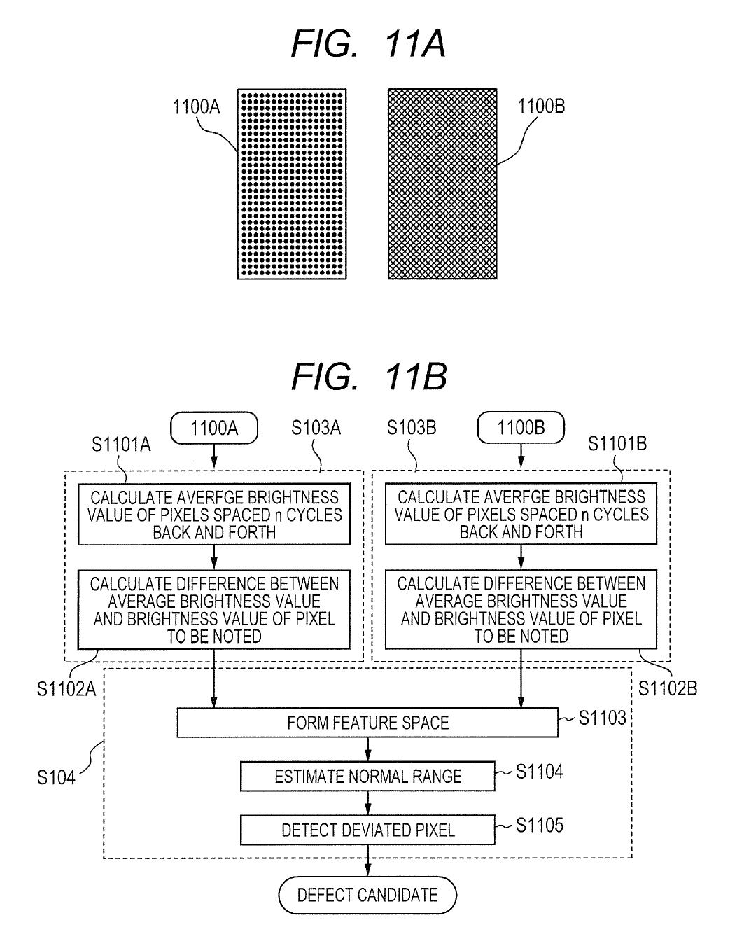

As described above, there has been explained the example in which the defect candidate of the pattern region having periodicity is detected from the image obtained in one optical condition. Further, however, each defect candidate can also be detected from images different in the combination of optical and detection conditions. An example thereof is shown in FIGS. 11A and 11B. 1100A and 1100B in FIG. 11A are images at specific positions on the wafer, which are obtained in conditions A and B that differ in the combination of optical and detection conditions.

On the other hand, the characteristics respectively calculated from the image 1100A and the image 1100B are consolidated to detect each defect candidate. A process flow thereof is shown in FIG. 11B. As with the process flow of S103 described in FIG. 9B, the average brightness values of pixels spaced n cycles back and forth are first calculated at S103A and S103B with respect to the images designated at 1100A and 1100B (S1101A and S1101B). The differences between the average brightness values and the brightness values of pixels of interest are calculated (S1102A and S1102B) and assumed to be feature values, respectively. As with the case described in the process flow of S104 in FIG. 9B, points corresponding to the feature values are plotted in two-dimensional space with the feature values calculated at S103A and S103B being taken as the axes to form feature space (S1103). A normal range is estimated from a distribution of the plotted points in the two-dimensional feature space (S1104). Each pixel that deviates from the normal range is detected as a defect candidate (S1105). As an example of estimation of the normal range, there is known a method for applying a normal distribution.

Nuisance defects and noise are removed from each defect candidate detected at the defect candidate detection unit 8-2. Sorting and size estimation corresponding to defect species are performed on the remaining defects at the post-inspection processing unit 8-3.

According to the present embodiment, even though there are a subtle difference in film thickness between patterns subsequent to a planarization process such as CMP, and a large offset in brightness between compared chips due to reducing a wavelength of illumination light, the extraction of each defect candidate by a defect determination system suitable for their regions is performed, thereby keeping a comparison between the chips at a minimum and realizing defect extraction unaffected by a region in which a difference in film thickness is large. Thus, a small defect (e.g., a defect or the like of 100 nm or below) can be detected with high sensitivity.

Upon inspection of low-k films like inorganic insulating films such as a porous silica film such as SiO2, SiOF, BSG, SiOB, etc. and organic insulating films such as SiO2 containing a methyl group, MSQ, a polyimide film, a parellin film, Teflon (Registered Trademark) film, an amorphous carbon film, etc., the detection of a small defect is enabled by the present invention even though a local difference in brightness due to in-film variations in refractive index distribution exists.

Although the one embodiment of the present invention has been explained by taking for example the comparison/inspection image in the dark field inspection device targeted for the semiconductor wafer, it can be applied even to an image comparison at an electron beam pattern inspection. It can also be applied even to a pattern inspection device with bright-field illumination.

The target to be inspected is not limited to the semiconductor wafer. If there are provided those in which a defect detection has been performed by an image comparison, the target to be inspected can be applied even to, for example, a TFT substrate, an organic EL substrate, a photomask, a printed board, etc.

### INDUSTRIAL APPLICABILITY

The present invention relates to an inspection which detects a fine pattern defect, a foreign material, etc. from an image (image to be detected) that is an inspection subject, which has been obtained using light or laser or an electron beam or the like. The present invention is applicable particularly to a device that performs a defect inspection of a semiconductor wafer, a TFT, a photomask, or the like.

### DESCRIPTION OF REFERENCE NUMERALS

1 . . . Optical section, 2 . . . Memory, 3 . . . Image processing section, 4a, 4b . . . Illumination units, 5 . . . Semiconductor wafer, 7a, 7b . . . Detection units, 8-2 . . . Defect candidate detection unit, 8-3 . . . Post-inspection processing unit, 9 . . . Entire control unit, 31, 32 . . . Sensor units, 36 . . . User interface unit.

1. A defect inspection device which inspects each of patterns formed on a sample, comprising:
table unit which places the sample thereon and is continuously movable in at least one direction;
image acquiring unit which images the sample placed on the table unit to acquire an image of each pattern formed on the sample;
split condition setting unit which sets conditions for splitting the image of the pattern acquired by the image acquiring unit in a plurality of regions; and
region-specific defect determining unit which splits the image of the pattern acquired by the image acquiring unit, based on the conditions for the splitting set by the split condition setting unit and performs a defect determination process suitable for the region for said each split region to detect each defect of the sample.

2. The defect inspection device according to claim 1, wherein the conditions for splitting the image of the pattern set by the split condition setting unit in the plural regions include any of a position of said each split region, a range thereof, the presence or absence of periodicity of a pattern for each region, a cyclic direction, the type of defect determination process, the priority of each defect determination process, etc.

3. The defect inspection device according to claim 1, further including region split condition inputting unit for inputting the conditions for splitting the image of the pattern in the plural regions.

4. The defect inspection device according to claim 1, wherein the split condition setting unit sets the conditions for splitting the image of the pattern in the plural regions, using design data of the pattern.

5. The defect inspection device according to claim 1, wherein the region-specific defect determining unit executes a plurality of defect determination processes corresponding to the split regions for said each split region and integrates results of the defect determination processes obtained by the execution to detect defects on the sample.

6. The defect inspection device according to claim 5, wherein the region-specific defect determining unit includes as one of the executed defect determination processes, a defect determination process which splits the inside of a region in small regions of finer units, calculates the cycle of each pattern for each small region, compares characteristics of each pixel in the small region with characteristics of a pixel spaced by the calculated cycle, and detects each outlier pixel from deviation value of characteristic quantity as a defect.

7. A defect inspection method which inspects each of patterns formed on a sample, comprising:
imaging the sample while continuously moving the sample to acquire an image of each pattern formed on the sample;
splitting the acquired image of the pattern, based on conditions for splitting the image of the pattern in a plurality of regions set in advance; and
performing a defect determination process suitable for the region for said each split region to detect a defect of the sample.

8. The defect inspection method according to claim 7, wherein the conditions for splitting the image of the pattern in the plural regions set in advance include any of a position of said each split region, a range thereof, the presence or absence of periodicity of a pattern for each region, a cyclic direction, the type of defect determination process, the priority of each defect determination process, etc.

9. The defect inspection method according to claim 7, wherein the conditions for splitting the image of the pattern in the plural regions are created using layout information about said each pattern.

10. The defect inspection device according to claim 7, wherein the conditions for splitting the image of the pattern in the plural regions are set using design data of said each pattern.

11. The defect inspection method according to claim 7, wherein a plurality of defect determination processes suitable for the split regions are executed for said each split region, and results of the defect determination processes obtained by the execution are consolidated to detect defects on the sample.

12. The defect inspection method according to claim 11, including as one of the executed defect determination processes, a process which splits the inside of a region in small regions of finer units, calculates the cycle of each pattern for each small region, compares characteristics of each pixel in the small region with characteristics of a pixel spaced by the calculated cycle, and detects each pixel brought to a characteristic deviation value as a defect.

13. A defect inspection method which inspects each of patterns formed on a sample, comprising:
imaging the sample while continuously moving the sample to acquire an image of each pattern formed on the sample;
processing the acquired image of the pattern and extracting an image region suitable for each pattern repeatedly formed in a specific cycle;
calculating a repetitive cycle of each pattern repeatedly formed in the specific cycle from the extracted image region;
comparing characteristics of images of the patterns repeatedly formed in the specific cycle with each other, using information about said each calculated repetitive cycle; and
detecting as a defect, a pattern in which a difference in characteristic is larger than a first threshold value set in advance, of the patterns repeatedly formed in the specific cycle.

14. The defect inspection method according to claim 13, further including:
processing the acquired image of each pattern to extract an image region corresponding to a non-cyclic pattern;
comparing characteristics of an image of the non-cyclic pattern present in an image obtained by imaging each of different regions on the sample and characteristics of an image of each pattern formed so as to have the same shape as the non-cyclic pattern;
detecting as a defect, a pattern in which a difference between the compared characteristics is larger than a second threshold value set in advance; and
consolidating a defect detected from an image region corresponding to each pattern repeatedly formed in the specific cycle and a defect detected from the image region corresponding to the non-cyclic pattern to detect each defect on the sample.
